(19) United States
(12) Patent Application Publication
(10) Pub. No.: US 2002/0030009 A1
(43) Pub. Date: Mar. 14, 2002

(54) Membrane and method for making same with consistent wicking properties for lateral flow assays

(76) Inventor: Ing Ching Lin, North Haven, CT (US)

Correspondence Address: CUMMINGS & LOCKWOOD, Granite Square, 700 State Street, P.O. Box 1960, New Haven, CT, 06509-1960, US

(21) Appl. No.: 09/899,877

(22) Filed: Jul. 6, 2001

Related U.S. Application Data
(60) Provisional application No. 60/217,020, filed on Jul. 11, 2000.

(51) Int. Cl. B01D 29/05

(52) U.S. Cl. 210/483; 210/488

(57) ABSTRACT

The present application discloses a reinforced microporous membrane suitable for use in immunodiagnostic assays, the reinforced microporous membrane having lateral flow properties useful in immunodiagnostic assays applications, the reinforced nylon microporous membrane also including a scrim that provides specific lateral flow properties such that the combination produced thereby is useful in immunodiagnostic assays applications and to methods for using such reinforced microporous membrane in lateral flow immunodiagnostic assays applications and methods of preparing and using such membranes.

### RELATED APPLICATIONS

This application is a continuation-in-part of commonly owned U.S. Provisional Patent Application Ser. No. 60/217,020, filed Jul. 11, 2000, of Lin, and is related to commonly owned U.S. patent application Ser. No. 09/022,295, filed Feb. 11, 1998, of Meyering et al., now U.S. Pat. No. 6,056,529, which is a continuation-in-part, of U.S. Provisional Patent Application Ser. No. 60/043,181, filed Apr. 11, 1997, of Meyering et al., U.S. patent application Ser. No. 09/040,979, filed Mar. 18, 1998, of Meyering et al. and U.S. patent application Ser. No. 09/040,816, filed Mar. 18, 1998, of Vining et al. and U.S. patent application Ser. No. 09/522,452, filed Mar. 9, 2000, of Meyering et al., which is a continuation-in-part, of U.S. Provisional Patent Application Ser. No. 60/123,459 of Meyering et al., filed Mar. 9, 1999, the disclosure of each is herein incorporated by reference to the extent not inconsistent with the present disclosure.

### BACKGROUND OF THE DISCLOSURE

The present disclosure relates to a membrane suitable for use in immunodiagnostic assays and methods of preparing and using same and, more particularly to a reinforced microporous membrane having lateral flow properties useful in immunodiagnostic assay applications and, most particularly, to a reinforced nylon microporous membrane having a scrim that provides specific lateral flow properties such that the combination produced thereby is useful in immunodiagnostic assay applications and to a method for using such reinforced microporous membrane in lateral flow immunodiagnostic assay applications.

There has been an expanding need for the development of diagnostic devices to detect substances in the physiological test samples for patients at home and in doctor's office without using sophisticated instruments. The advantage of lateral flow immunoassay is that the device can offer a simple, one-step analysis with accurate results within several minutes when executed by less-skilled or unskilled personnel. Typical at home and in doctor's office applications include pregnancy test and Streptococcus assay kits.

Membranes have become invaluable tools in the clinical arts. Specifically, membranes are integral to immunodiagnostic assays. However, currently available membranes possess qualities that limit their utility within the context of the foregoing applications.

Immunodiagnostic assays are generally performed by applying a test liquid containing antigens to a porous membrane containing antibodies. As the test liquid laterally diffuses through the membrane, antibodies will bind antigens to which they are directed with a high degree of specificity. The binding of the antibodies to the antigens serves as a detection means (e.g., the visualization of the presence of antigens), and the specificity with which antibodies bind to antigens allows for the determination of whether or not the test liquid contains specific antigens. Therefore, in immunodiagnostic assays, the membrane desirably possesses optimal immunodiagnostic properties. In other words, it is desirable that the membrane allow for optimal lateral diffusion of the test liquid, allow for adequate visualization of the existence of antigens in the test, allow for adequate protein binding, is hydrophilic, is capable of being uniformly manufactured in order to yield consistent results and is safe to use.

The most common types of membranes available for use in immunodiagnostic are cellulose-based membranes (e.g., nitrocellulose and cellulose acetate membranes). Both of these membranes, however, possess qualities that limit their utility in the foregoing applications. Nitrocellulose is prepared by the nitration of naturally occurring cellulose. During nitration, a broad distribution of heterogeneous oligomeric and polymeric nitrated products is produced as a consequence of the partial acid digestion of cellulose. Exacerbating the problem is the fact that the purity of the cellulose starting material depends on its source and pre-nitration treatment. Consequently, uniformity in the manufacture and in the finished product(s) of nitrocellulose membranes is difficult to achieve. For similar reasons, it is also difficult to achieve uniformity in the manufacture of other cellulosic membranes, such as cellulose acetate membranes. Furthermore, nitrocellulose membranes present numerous laboratory safety concerns by virtue of their flammability and explosiveness. Cellulose acetate and nitrocellulose membranes are also disadvantageous in that such membranes are very brittle, easily broken and difficult to wet using aqueous solutions (hydrophobic).

Typically, large pore size nitrocellulose membranes with pore size from about two (2) to about twenty (20) microns are used in lateral flow immunoassay applications. As discussed above, there are many problems with using nitrocellulose membrane for lateral flow applications including, but not limited to, the fragile nature of the membrane making it difficult to handle in the manufacturing process, the laminated version of nitrocellulose membrane improves the mechanical strength, but suffers from a non-uniform wicking front, and, more importantly, nitrocellulose membrane has inconsistent properties such as wicking and protein binding due to the nature of nitrocellulose resin itself and the manufacturing process of nitrocellulose membrane.

The problems of inconsistent wicking performance or uneven flow of assay have been addressed in the following U.S. Pat. No. 5,885,527, entitled: “Diagnostic devices and apparatus for the controlled movement of reagents without membranes” and U.S. Pat. No. 5,770,460, entitled: “One-step lateral flow nonbibulous assay”, the disclosure of each is herein incorporated by reference to the extent not inconsistent with the present disclosure.

Prior attempts to improve the membrane strength have been addressed by the following U.S. Pat. No. 4,340,479, entitled: “Process for preparing hydrophilic polyamide membrane filter media and product”; U.S. Pat. Nos. 4,707,265 and 4,645,602, entitled: “Reinforced microporous membrane” and U.S. Pat. No. 5,500,167, entitled: “Method of preparing a supported microporous filtration membrane”, the disclosure of each is herein incorporated by reference to the extent not inconsistent with the present disclosure.

Examples of attempts in the prior art to improve the wicking properties include: U.S. Pat. No. 5,885,527, accomplished by a complicated mechanical device and eliminating the use of membrane and U.S. Pat. No. 5,770,460, accomplished by converting a bibulous support to a nonbibulous support through coating, the disclosure of each is herein incorporated by reference to the extent not inconsistent with the present disclosure.

U.S. Pat. Nos. 4,340,479, 4,707,265 and 5,500,167, the disclosure of each is herein incorporated by reference to the extent not inconsistent with the present disclosure, addressed the benefits of using supported or reinforced membrane to improve the membrane strength and filtration integrity. None of these patents addressed the wicking performance of the membrane. Furthermore, some of the scrim used for reinforcing the membrane had adverse effects on the wicking performance of the membrane when used in immunodiagnostic assay applications.

Nitrocellulose is the membrane of choice for almost all commercially available lateral flow in vitro diagnostic (IVD) tests. One of the biggest problems of nitrocellulose is its physical weakness. Specifically, nitrocellulose is brittle and has very low tensile strength. In particular, as the pore size increases, the tensile strength decreases and the more brittle the nitrocellulose membrane becomes. Often, a non-porous backing layer of Mylar (or some other film) is required to be bonded to the nitrocellulose, simply for handling the membrane during production. However, it is believed that a scrim-reinforced nitrocellulose membrane is not available.

Based on the foregoing problems, there exists a need for membrane that can be used more effectively in immunodiagnostic assays for lateral flow IVD applications. Such a membrane should possess better tensile strength to facilitate handling and converting than the current prior art membrane used in lateral flow diagnostic applications. Such a membrane should have fast, consistent and uniform wicking properties for dependable performance and accurate results when used in lateral flow diagnostic applications. Such a membrane should at least reduce, if not eliminate, weak membrane strength when used in lateral flow diagnostic applications. Such a membrane should at least reduce, if not eliminate, inconsistent wicking associated with nitrocellulose membrane when used in lateral flow diagnostic applications. The present disclosure provides such a membrane and methods for the preparation thereof.

These and other advantages of the present disclosure, as well as additional inventive features, will be apparent from the description of the disclosure provided herein.

### SUMMARY OF THE DISCLOSURE

An object of the present disclosure is to provide a physically strong, reinforced membrane, as compared to nitrocellulose membrane, useful in lateral flow immunodiagnostic assay applications.

Another object of the present disclosure is to provide a reinforced membrane having increased tensile strength, as compared to nitrocellulose membrane, when used in lateral flow immunodiagnostic assay applications.

A further object of the present disclosure is to provide a reinforced membrane having a low coefficient of variation (CV) in its flow characteristics when used in lateral flow immunodiagnostic assay applications.

Yet a further object of the present disclosure is to provide a reinforced membrane having a sufficiently high binding capacity to retain capture zone molecules in lateral flow immunodiagnostic assay applications.

Yet another object of the present disclosure is to provide a reinforced membrane having a fast and reproducible wicking rate.

Still another object of the present disclosure is to provide a reinforced membrane whose non-specific binding can be controllably blocked in lateral flow immunodiagnostic assay applications.

Another object of the present disclosure is to provide a reinforced membrane having improved uniformity when used in lateral flow immunodiagnostic assay applications.

A further object of the present disclosure is to provide a reinforced membrane that is water wettable without surfactants when used in lateral flow immunodiagnostic assay applications.

Yet a further object of the present disclosure is to select and use a reinforcing scrim which exhibits high uniformity of properties on the scrim surface, exhibits high uniformity of thickness, exhibits high uniformity of distribution of fibers, and exhibits high uniformity of macro and micro appearance when used in reinforced microporous membrane for lateral flow diagnostic assay applications.

In accordance with these and further objects, one aspect of the present disclosure includes three zone microporous membrane suitable for use in immunodiagnostic assays comprising: a porous scrim substantially impregnated by a first dope to form a middle zone having two sides; and a second zone and a third zone formed from the same dope as the middle zone, each zone having inner and outer surfaces, each of the second and third zones being operatively, continuously, connected to opposite sides of the middle zone, wherein the porous scrim has a basis weight of about ten (10) to about sixty (60) g/m².

Another aspect of the present disclosure includes a method of using the membrane of the present application to detect an analyte of interest comprising, contacting the membrane with a fluid believed to contain the analyte of interest; and detecting the analyte of interest if present in the fluid.

Still another aspect of the present disclosure includes a method of preparing a reinforced microporous membrane for use in immunodiagnostic assays comprises: selecting a scrim having the properties from the group comprising: a fiber forming polymer (including but not limited to polyesters, polyamides, polyimides and polyolefins) or combination of polymers in fibrous form capable of forming a fibrous web or mat which is useful as a membrane casting substrate either directly after formation or after post treatments such as binder addition, calendering and corona treatment. The polymer fibers or blend of fibers or blend of fibers and binder(s) may be also treated during formation with the addition of a non-fibrous binder formulation. An example of a suitable polyester fiber might be: Polyethylene Terephthalate (PET), or a combination of Polyethylene Terephthalate/Polyethylene Imine (PET/PEI) fiber blend, where the PEI fiber is used as a binder fiber. Alternatively, a separate polymeric treatment may be used, such as an acrylic binder, to effect bond strength and uniform tie-down of the structural PET fiber mat; Basis weight: the scrim must have a basis weight of about ten (10) to about sixty (60) g/m², more preferably about twenty-five (25) to about forty-five (45) g/m² and most preferably, about thirty (30) to about forty-two (42) g/m²; Thickness: the scrim must have a thickness of about one (1.0) to about four (4.0) mils; Tensile strength: the scrim must have a tensile strength of about three (3.0) lb./in. minimum for the cross direction (CD) and about five (5) lb./in. minimum for the machine direction (MD) or Frazier air permeability: the scrim must have a Frazier air permeability of about ten (10) CFM minimum to about five hundred (500) CFM, more preferably about fifteen (15) to about one hundred fifty (150) CFM and most preferably, about twenty (20) to about thirty-five (35) CFM and providing the selected scrim as a continuous support material having first and second sides; at least substantially pressure impregnating the scrim with a first polymer dope utilizing a first die means; passing the polymer dope impregnated continuous scrim between substantially opposed second and third die means; and substantially simultaneously coating both sides of the first polymer dope impregnated continuous support material with the same polymer dope, the polymer dope should produce membrane having a relatively large pore size, of high uniformity from point to point.

Another aspect of the present disclosure includes an immunodiagnostic assay kit comprising the membrane of the present application and a mean for detecting an analyte of interest.

Other objects and advantages of the disclosure will be apparent from the following description, the accompanying drawings and the appended claims.

### BRIEF DESCRIPTION OF THE DRAWINGS

FIG. 1 is a cross-section of one representative membrane according to the present disclosure;

FIG. 2 is a schematic representation of one representative method and apparatus by which the present disclosure may be produced;

FIG. 3 is an enlarged perspective view of a scrim positioned between the opposed dies of FIG. 2, with a portion of one die partially broken away; and

FIGS. 4 is a graphic representation of the wicking fronts of the test conducted in Example 2.

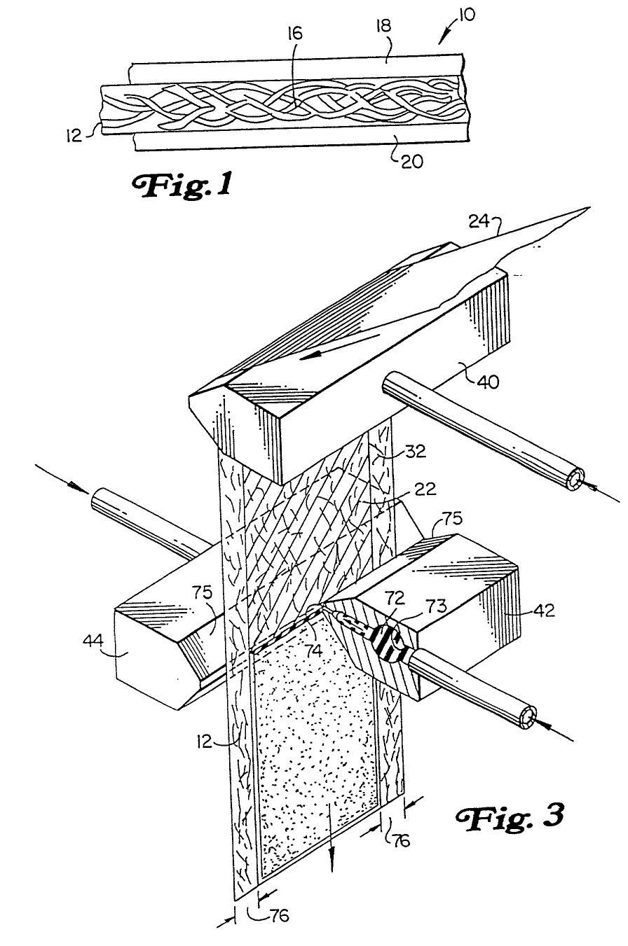

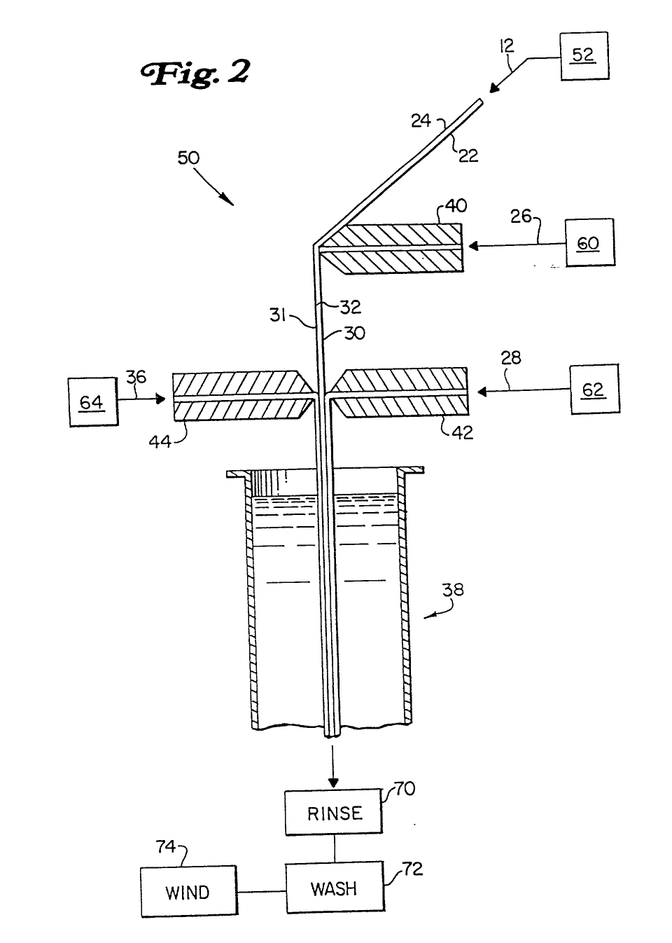

### DETAILED DESCRIPTION OF REPRESENTATIVE EMBODIMENTS OF THE DISCLOSURE

The present innovative reinforced microporous membrane is suitable for use in immunodiagnostic assays and methods of preparing and using same. The membranes described herein are made, presently preferably, from nylon polymer by quenching in a non-solvent system. Such a membrane for use in immunodiagnostic assays not only provides a more consistent process but also uses a more uniform polymer than the nitrocellulose presently used in immunodiagnostic assays.

As stated in the background of the disclosure, an object of the present disclosure to select and use a reinforcing scrim which exhibits high uniformity of properties on the scrim surface, exhibits high uniformity of thickness, exhibits high uniformity of distribution of fibers, and exhibits high uniformity of macro and micro appearance when used in reinforced microporous membrane for lateral flow diagnostic applications.

By highly uniform, it is meant to be distinguished from the typical reinforcing non-woven scrims which have been commercially employed in the production of nylon microporous membranes, such as spun bonded Hollytex 3256, 3257, or Freudenberg F02432, and variations thereof, which were selected primarily for their suitability in filtration applications. Scrims for filtration are generally expected to be somewhat uniform, thin, very open in porosity and pore volume, and (once cast into a membrane), substantially non-restrictive to flux or throughput of the filtrate, i.e. flow rate.

Scrims for use with the present application need not be selected based on these properties. Surprisingly, it has been found that the best scrims for lateral flow application do not exhibit good transmembrane flow rates, once cast into a membrane structure. This may explain why these scrims have been ignored in the past by microporous filter manufacturers.

To validate the choice of the scrim, it is essential to focus on application testing after impregnation, coating, and quenching, to prove that the combination of scrim and large pore size membrane can deliver the requisite uniformity in both wicking rate and wicking front, both down web and across the web. It is difficult, based strictly on scrim attributes alone, to predict whether or not a particular combination of scrim and membrane will succeed in delivering these levels of quality. It is believed at the present time that, for guidance in selecting a scrim, the important factors are high levels of uniformity in surface properties, thickness, distribution of fibers, and the scrim's macro and micro appearance, and (from the above discussion), sufficient density and coverage of fiber to be somewhat restrictive to transmembrane flow when compared to standard reinforcement scrims, as used in filtration applications. This restrictive attribute may be measurable by tests such as Frazier air permeability. The successful scrims in immunodiagnostic assay applications may have air permeability anywhere from about fifty percent (50%) or more to about ten percent (10%) or less of a standard scrim used as reinforcement in filtration membranes.

A particularly advantageous scrim for use in lateral flow diagnostic applications has been found to be Ahlstrom Hollytex 3703, which is a wetlaid polyester short-fiber mat, calendered to a density which would render it less than desirable for filtration membrane purposes.

The innovative membranes of the present application may be produced according to the systems and methods described in U.S. Pat. No. 6,056,529 and U.S. patent application Ser. No. 09/522,452, filed Mar. 9, 2000, of Meyering et al., which is a continuation-in-part, of U.S. Provisional Patent Application Ser. No. 60/123,459 of Meyering et al., filed Mar. 9, 1999 and has a tight and accurate temperature control. The use of this technology enables a large pore size membrane with a uniform pore size and pore size distribution to be manufactured for use in immunodiagnostic assays.

It has been determined that the weak strength and inconsistent wicking problems of the prior art nitrocellulose membrane used in immunodiagnostic assays were solved by incorporating a specially selected scrim into the membrane structure. This combination of a specially selected scrim and uniform dope not only provides a reinforced membrane having a higher tensile strength but also contributes to the wicking consistency essential for immunodiagnostic assay applications. The combination of scrim structure and microporous membrane provides the ability to control the movement of the solution in the new membrane and scrim combination during lateral flow with a consistent flow rate and flow front.

As stated above, the specific scrim, which has been found to be highly effective, is Hollytex 3703 made from a proprietary process by Ahlstrom Filtration, Inc. The Hollytex 3703 scrim is made by wetlaid process using a blend of large and small polyester fibers and a small percentage of acrylic binder. The combination of wetlaid process and fiber composition provides a uniform structure and porosity. The Hollytex 3703 scrim is further calendered to increase the tensile strength and surface smoothness.

The presently preferred final scrim product has a thickness of about 2.9 mils, a basis weight of about 36.9 g/m², a cross direction of about 5.3 lb./in. tensile strength, a machine direction of about 8.6 lb./in. tensile strength and an air permeability of about 24.2 CFM. The Hollytex 3703 scrim has a MFP (Mean Flow Pore) pore size of about 17.7 um. This pore size is relatively close to the membrane pore size used for lateral flow assay applications. This similarity of pore size between the membrane and supporting scrim is believed to reduce the adverse impacts of the scrim structure on the lateral flow and to contribute to the uniform and consistent wicking properties of the reinforced microporous membrane, as illustrated in the examples below. Other scrims which also have been found to possess improved wicking properties over the current state of the art include, but are not limited to: Crane 886 and Crane 912, which were made by a similar wetlaid process as the Hollytex 3703 scrim.

These two particular Crane scrims have been found to provide improvements in uniformity and consistency to a lesser degree than the Hollytex 3703 scrim. It should be understood that the present application is not intended to be limited to these particular scrims but is intended to encompass all scrims that are effective in improving the required uniformity and consistency of the membranes described herein when used for lateral flow immunodiagnostic assay applications.

Based on the data obtained from the analysis of the above particular scrims, the following is believed to define the general properties required for microporous membrane casting substrates or scrims when used for lateral flow immunodiagnostic assay applications as described in the present application.

As is known, a casting substrate web or scrim is a thin and highly uniform porous matrix used for supporting membrane to enhance the strength and handling of the finished combination reinforced microporous membrane. The material comprising the scrim must have sufficient strength and uniformity to withstand the rigorous requirements of reinforced membrane fabrication. The scrim material must also provide the final reinforced microporous membrane product with the desired chemical resistance and cosmetic appearance. In general, any number of fiber-forming polymers, including poly-olefins, -aramids, -imides, -amides, etc. may be used advantageously in this disclosure. The fibers can be selected from shapes (round, trilobal, etc.) and sizes (continuous, staple, etc.) amenable to their respective web formation technique, and the fiber mat or scrim formed therefrom may be selected from a plurality of common manufacturing techniques, including woven materials and nonwoven materials. The nonwovens known to be useful include spunbonded fibrous webs, melt-blown fibrous webs, wet-laid fibrous webs and air-laid fibrous webs. Engineered plastic sheets may also be of use, such as expanded mesh nonfibrous continuous mat.

These fibrous webs may have their attributes modified advantageously with common finishing techniques, such as heat calendering, to produce the finished casting scrim, or they may be used as is, depending on the method of manufacture. Given that there is such a plurality of scrims available, the selection of a suitable scrim which enhances the overall uniformity and utility of the finished lateral flow membrane is not obvious.

Presently, the most common type of scrims available for use is made from polyester fibers or polypropylene fibers.

As a useful screening criteria for selecting candidate scrims, it is believed that the following guidelines can be used as a starting point.

The polymer used to make the scrim should be a fiber forming polymer (including but not limited to polyesters, polyamides, polyimides and polyolefins) or combination of polymers in fibrous form capable of forming a fibrous web or mat which is useful as a membrane casting substrate either directly after formation or after post treatments such as binder addition, calendering and corona treatment. The polymer fibers or blend of fibers or blend of fibers and binder(s) may be also treated during formation with the addition of a non-fibrous binder formulation. An example of a suitable polyester fiber might be: Polyethylene Terephthalate (PET), or a combination of Polyethylene Terephthalate/Polyethylene Imine (PET/PEI) fiber blend, where the PEI fiber is used as a binder fiber. Alternatively, a separate polymeric treatment may be used, such as an acrylic binder, to effect bond strength and uniform tie-down of the structural PET fiber mat.

Basis weight: the scrim must have a basis weight of about ten (10) to about sixty (60) g/m², more preferably about twenty-five (25) to about forty-five (45) g/m² and most preferably, about thirty (30) to about forty-two (42) g/m².

Thickness: the scrim must have a thickness of about one (1.0) to about four (4.0) mils.

Tensile strength: the scrim must have a tensile strength of about three (3.0) lb./in. minimum for the cross direction (CD) and about five (5) lb./in. minimum for the machine direction (MD).

Frazier air permeability: the scrim must have a Frazier air permeability of about ten (10) CFM minimum to about five hundred (500) CFM, more preferably about fifteen (15) to about one hundred fifty (150) CFM and most preferably, about twenty (20) to about thirty-five (35) CFM.

The scrim surface should be substantially free of lift fibers, i.e., fibers that are lifted above the normal surface of the scrim on either side, as is known in the art.

The starting point screening specification for polypropylene substrates or scrims is the same as polyester substrate, except that the basis weight is most preferably from about twenty (20) to about thirty-five (35) g/m².

As mentioned before, there are many other fiber forming polymers which will be suitable for use in the present disclosure. Additionally, there are bicomponent classes of polymer fibers, in which many if not all fibers contain two separate polymer compositions, arranged as an outer sheath and an inner core. Both sheath and core can be produced using a plurality of possible cross sectional shapes, either as continuous shapes or discontinuous shapes. One common shape is the concentric annular circle of sheath containing within it a circle of core. Generally, the outer sheath polymer or formulation is designed to have binding characteristics either by melt or adhesive, and the inner polymer is designed to have structural properties which provide the finished substrate or scrim with superior strength and handling.

One representative inventive method of preparing a reinforced microporous membrane for use in immunodiagnostic assays comprises: selecting a scrim having the above properties and providing the selected scrim as a continuous support material having first and second sides; at least substantially pressure impregnating the scrim with a first polymer dope utilizing a first die means; passing the polymer dope impregnated continuous scrim between substantially opposed second and third die means; and, substantially simultaneously coating both sides of the first polymer dope impregnated continuous support material with the same polymer dope, the polymer dope should produce membrane having a relatively large pore size, of high uniformity from point to point. The reinforced microporous membrane should, upon evaluation, deliver highly uniform lateral flow wicking rates from point to point, across and down web, as is understood in the art.

As is known in the art, reinforced membrane used in lateral flow immunodiagnostic assays applications is, by necessity, porous. The desired pore size of the membrane is a function of the desired wicking time. The larger pore size membranes have provided faster wicking time than have the smaller pore size membranes. Preferably, the pore size of the membrane, as detected by Bubble Point techniques (examples include but are not limited to: Initial Bubble Point or Foam All Over Point), is in the range of about 1.0 micron to about 20 microns; more preferably, the pore rating is in the range of about 5.0 microns to about 15.0 microns; and most preferably, the pore rating is in the range of about 8.0 microns to about 12.0 microns.

The present inventive reinforced membrane can be used within the context of any application where it is desired to detect an analyte of interest. While the membrane can be used in any suitable way, presently preferably, the method for using the present inventive membrane comprises: contacting the membrane with a fluid comprising the analyte of interest, allowing the fluid to laterally diffuse through the membrane, and detecting the analyte of interest on the membrane.

Another representative embodiment of the present disclosure is an immunodiagnostic assay kit, which can be used for IVD assays. The immunodiagnostic assay kit, presently preferably, comprises a reinforced membrane, as disclosed in the present application, and a means for detecting an analyte of interest. While any suitable detection means can be utilized within the context of the present disclosure, the detection means is presently preferably a colloidal metal, colloidal gold, colored liposomes, colored polymeric beads, polymerized dye molecule, or other visible substance which can be conjugated with an analyte-specific detection molecule.

As previously stated, optimal immunodiagnostic properties include a membrane's ability to be safely used in a laboratory environment (e.g. the membrane is not flammable or explosive), its ability to be uniformly manufactured in order to yield consistent experimental results and its hydrophilicity. Further, optimal properties include the membrane's ability to strongly bind analyte-specific molecules of interest. Additionally, the membrane must be able to be further treated with appropriate blocking treatment which allows free lateral passage of labeling and/or detection conjugates of analyte or signal generating moieties which, if not blocked, would result in non-specific signal (i.e. the membrane is capable of a high signal-to-noise ratio). Therefore, any membrane prepared by the foregoing preparative methods can be tested for its immunodiagnostic properties, and the process conditions of the preparative method can be adjusted in response to the test so as to enhance or otherwise alter the immunodiagnostic properties of the membrane produced therefrom.

### EXAMPLES

The following example is directed to the production of reinforced microporous lateral flow membrane, including the preparation of a mother dope, thermal manipulation of the mother dope by a Dial-A-Por™, casting, quenching, washing, drying and evaluation. In order to make large pore size (2 to 20 micron) lateral flow microporous membrane, the mother dopes are first formulated to produce an about 0.8 micron type microporous membrane. The mother dope is used to produce a larger pore size dope by a Dial-A-Por™ system and then apply the large pore size dope to a scrim by a dope application mechanism or means to make the combination of large pore size microporous membrane on the high uniformity scrim, similar to that described in U.S. patent application Ser. No. 09/040,979, filed Mar. 18, 1998, of Meyering et al. and U.S. patent application Ser. No. 09/040,816, filed Mar. 18, 1998, of Vining et al. and U.S. patent application Ser. No. 09/522,452, filed Mar. 9, 2000, of Meyering et al., which is a continuation-in-part, of U.S. Provisional Patent Application Ser. No. 60/123,459 of Meyering et al., filed Mar. 9, 1999.

### Example 1

A mother dope, identified as Dope # 99M001, of about twelve percent (12%) by weight Nylon 66 (Dupont Zytel E53), about eighty-one and four-tenths percent (81.4%) by weight formic acid and about six and six-tenths percent (6.6%) by weight methanol, was produced by the method disclosed in U.S. Pat. Nos. 3,876,738 and 4,645,602, the disclosure of each is herein incorporated by reference to the extent not inconsistent with the present disclosure.

After the nylon was added to the mixture, the dope was processed in a vessel to a maximum temperature of about twenty-eight degrees Celsius (28° C.) and allowed to mix as per the normal cycle. To gain an appreciation of the pore size of a microporous nylon membrane cast directly from this mother dope, a small portion (˜100 cc) of the mother dope was cast and quenched in a laboratory apparatus which simulates the casting process described in U.S. Pat. No. 3,876,738, to Marinaccio and Knight. The finished lab cast membrane had a thickness of about 8.1 mils, Initial Bubble Point of about 20.4 psi and Foam All Over Point of about 22.3 psi. This was evidence that the mother dope, as formulated and produced for this example, had a nominal pore size of about 0.8 microns prior to being processed by the Dial-A-Por™ unit, and further processed into large pore size microporous nylon membrane by a vertical casting apparatus at a dope processing site.

After the above tests, the storage vessel containing the above mother dope was operatively connected to the Dial-A-Por™ system for thermal manipulation of the mother dope. Then, the vessel was pressurized to about forty-five (45) psi with nitrogen, to move the dope from the vessel to a single Dial-A-Por™ unit, the Dial-A-Por™ unit was operatively connected via a three-way distribution header to three separate precision metering pumps for transporting precise amounts of thermally manipulated dope to each of the three coating dies, using equipment as disclosed in U.S. patent application Ser. No. 09/522,452.

The Dial-A-Por™ system for thermal manipulation (elevation of the dope to a predetermined temperature) was activated and the target temperature was set to the specific target temperature for the dope to be delivered to the three slot dies. When the two heating mechanisms (coarse heating and fine-tune heating) and the cooling mechanisms reached their respective target temperatures, dope valves were opened and dope was moved under pressure from the sealed vessel through the Dial-A-Por™ unit, then on to the distribution header and into each of three precision metering pumps and each of three respective impregnation or coating dies.

The specific target temperature for the Dial-A-Por™ unit was fifty-three and one half degrees Celsius (53.5° C.) to effect a substantially lower bubble point dope attribute, followed by cooling to about twenty-one degrees Celsius (21° C.), to effect a useful dope viscosity for impregnation and coating.

At the dope processing site, a highly uniform non-woven polyester fiber web or scrim suitable for preparation of the lateral flow membrane (commercially available from Ahlstrom, Inc. Product Grade # Hollytex 3703), having a basis weight of nominally 1.06 oz./sq.yd. (36 gm./sq.meter) was processed by the method taught in the Ser. Nos. 09/040,979 and 09/040,816 applications. The scrim was pre-treated with a mild corona discharge to enhance its wettability before being pressure impregnated. The relatively larger pore size dope, was provided from the Dial-A-Por™ unit operatively connected to the first slot die (or Membrane Zone One impregnating die) and was used to pressure impregnate the scrim, with an impregnation weight of about ten and nine-tenths (10.9) gm/sq.meter of nylon solids. The nylon solids were provided from the dissolved nylon in the dope solution, which were, in this example, a twelve percent by weight (12 wt. %) nylon solution (about ninety-one, 91, grams of liquid dope per square meter), which was sufficient to impregnate and fill the void volume of the scrim, and leave a small excess of coating dope on the application side of the scrim creating the first zone of large pore size dope integral with the supporting scrim.

Within a short distance of travel following the pressure impregnation of the scrim with the dope from the first slot die, both sides of the pressure impregnated scrim were essentially simultaneously coated with dope received from the other two slot dies, as described above. The relative amounts of dope per side was adjusted to roughly balance the total coating weight on both sides, and result in a finished coating weight of approximately thirty-four, 34, grams of nylon solids per square meter (including impregnation weight), therefore, approximately twenty-three and one-tenth, grams (23.1), per square meter were distributed between the other two coating slot dies.

After two-side simultaneous quenching, washing and restrained drying, the resultant finished membrane achieved a continuous, substantially geometric symmetry around the neutral axis of the reinforcing scrim, and the same pore size attributes on both sides of the scrim. (i.e., Pore Size Symmetric).

The resultant three-zone, geometrically symmetric, pore size symmetric, reinforced, nylon microporous lateral flow membrane of this Example had the measured attributes as illustrated in the following Table 1.

TABLE 1

| | MFP(1) | | | QC | | | |
|---|---|---|---|---|---|---|---|
| | Avg. | | | Thick | FAOP | IBP | Tₘₐₓ |
| Roll | um | Std dev. | % CV | mils | psi | psi | ° C. |
| 99M001-07 | 4.523 | 0.133 | 2.9 | 6.1 | 4.6 | 3.4 | 53.5 |

(1)MFP test is a Coulter Porometer I, using Porofil ® test fluid, in a 35 mm housing.

The above data demonstrated that the Dial-a-Por™ unit had successfully manipulated the dope having about a 22.3 psi Foam All Over Point to produce about a 4.6 psi Foam All Over Point finished reinforced microporous membrane, using the Ahlstrom Hollytex 3703 reinforcing scrim.

It should be noted that, in this and all other examples of the presently believed best mode using the Hollytex 3703 reinforcing scrim, that the most reliable and effective measurements for differentiation of the finished membrane are the bubble point measurements, those being the Initial Bubble Point (IBP) and the Foam All Over Point (FAOP). Surprisingly, the Coulter Mean Flow Pore measurement is not suitable for measuring and differentiating between large pore size membrane pore structures which contain the (very tight, low Frazier air permeability around about 30 CFM) preferred reinforcement scrim of the present application. This is believed to be due to the occlusion of scrim porosity, which is already tight, mated with a microporous membrane structure. The pore size of the preferred scrim alone is approaching the pore size of the large pore membrane structure. The combination leads to occlusion of scrim pores, and provides a limiting airflow in the wet-vs.-dry airflow curves that are now superimposed upon one another in Coulter porosimetry. Thus, the standard model of 50% dry airflow can no longer be used to estimate mean flow pore size of the nylon membrane structure, and the reported results are in error. It should be noted that, when a standard filtration scrim (such as Hollytex 3257) is substituted into the present example 1 membrane, the Coulter Mean Flow Pore measurement can be as high as 8 to 10 microns. This is consistent with the particular bubble points shown here. With a standard filtration scrim (being quite open, having Frazier air permeability rates around about 275 CFM or higher), there is no appreciable occlusion of scrim pores, and no appreciable limiting function to the air flow measurements. For the present examples, Coulter Mean Flow Pore measurements are taken as a routine, and are reported as is, despite this limitation.

The length of the roll of the membrane produced was about 950 feet. The produced about 950 foot roll was then dissected into 9 separate rolls of about 100 foot length, and each of the 9 rolls were sampled and tested for their water wicking rate, where wicking was measured on samples cut about one inch (1″) wide by about three inches (3″) high, oriented such that the capillary rise occurred in the crossweb direction, as opposed to the machine direction. The measurement was, from the point of contact with deionized water, timed from a point on the membrane immediately above the point of wetting, to a point about four (4) centimeters above the first mark. The time was measured in seconds. From each of the nine separate rolls, six (6) individual replicate samples were cut, thus, a total of 54 tests were performed. The individual wick rates from these tests were as shown in the following Table 2;

TABLE 2

| Individual Values | | | | | | Statistics | |
|---|---|---|---|---|---|---|---|
| 80.0 | 77.3 | 80.0 | 81.5 | 80.2 | 79.9 | Avg | 79.4 |
| 75.8 | 78.2 | 77.7 | 78.7 | 83.3 | 79.5 | Std Dev | 2.16 |
| 81.0 | 78.8 | 79.5 | 82.6 | 76.9 | 79.7 | % CV | 2.73 |
| 78.6 | 75.1 | 81.4 | 80.9 | 76.0 | 79.1 | Min time | 75.1 |
| 78.5 | 80.4 | 77.6 | 85.3 | 77.4 | | Max time | 85.3 |
| 82.2 | 78.8 | 77.4 | 81.0 | 78.5 | | | |
| 77.4 | 78.5 | 80.6 | 81.4 | 77.8 | | | |
| 75.9 | 82.7 | 79.9 | 77.3 | 82.8 | | | |
| 81.9 | 78.0 | 79.5 | 81.1 | 76.9 | | | |

There were no discernible trends in the data that might indicate an increase or decrease in wicking time along the length of the membrane. The coefficient of variation percent (CV %) indicated by this data represents a competitive advantage.

Competitive Analysis

Coefficient of Variation (CV) comparison data

CUNO Roll 99M001-07 from Example 1 (Nylon membrane)

Pall grade Biodyne A, 5 um (lot # 055541) (Nylon membrane)

Schleicher & Schuell grade AE100 (lot #BV0681-1) (Nitrocellulose membrane)

Across a 10 foot length of competitive membrane samples at nominally 12 inch width, the samples were divided into six sub-samples of equal length. From each of the six (6) sub-samples was cut two sets of three strips, each strip was one inch (1″) wide by three inches (3″) high, oriented (again) such that the 3″ dimension faced in the crossweb direction. Each of the three strips represents a separate lane or track with respect to the crossweb direction. In other words, whereas downweb represents position along the length of the roll, crossweb represents position across the width. The nominally 12″ width was thus subdivided into three tracks of nominally 4″ width. The identity of the tracks was assigned Track 1 as the near edge, Track 2 as the center, and Track 3 as the far edge. Here, near and far are determined from the perspective of the operator, by orientation as the roll is unwound on a spindle which is pointing at the operator, turning clockwise as material feeds off the top of the roll, as the sheet is being pulled from left to right. This assignment was consistent with all membranes tested.

Thus, each set of three (3) strips was sampled at the same downweb position, representing three tracks crossweb. A second set of three (3) strips was likewise sampled at a small offset, approximately one and one half inches (1.5″) downweb of the first position, thus there are two sets of three (3) strips reported for each of the above mentioned six sub-samples. Results are traced and reported separately for each set of three (3) strips.

These strips were tested for capillary rise wicking rate in DI water as before, such that the capillary rise occurred in the crossweb direction. As before, the water wicking rate measurement is, from the point of contact with deionized water, timed from a point on the membrane immediately above the point of wetting, to a point about four (4) centimeters above the first mark. The water wicking rate time is measured in seconds.

A mean value and standard deviation was determined for each of the two sets of three strips, in all six sub-sample positions. A CV was calculated from each of the set of three (3) strips (note CV %=(Std. dev/mean)×100). Reference should be made to tables 3 (Pall), Table 4, (Schleicher and Schuell—S&S) and Table 5 (Cuno) for the details of the test results.

Master tables of CV data for each of the manufacturers' products are shown in Table 7 below.

TABLE 3
(Pall Biodyne A 5 um)

| | Cross Direction | | | | | |
|---|---|---|---|---|---|---|
| | Track 1 | Track 2 | Track 3 | Avg. | Std dev | % CV |
| 1 | 153.5 | 134.9 | 151.6 | 146.7 | 10.2 | 7.0 |
| | 136.0 | 124.1 | 153.3 | 137.8 | 14.7 | 10.7 |
| 2 | 119.2 | 113.6 | 132.5 | 121.8 | 9.7 | 8.0 |
| | 111.1 | 128.0 | 110.6 | 116.6 | 9.9 | 8.5 |
| 3 | 114.2 | 99.9 | 119.5 | 111.2 | 10.1 | 9.1 |
| | 107.6 | 109.8 | 126.0 | 114.5 | 10.1 | 8.8 |
| 4 | 111.5 | 110.2 | 112.2 | 111.3 | 1.0 | 0.9 |
| | 126.8 | 105.3 | 123.1 | 118.4 | 11.5 | 9.7 |
| 5 | 131.8 | 119.8 | 102.4 | 118.0 | 14.8 | 12.5 |
| | 107.4 | 117.0 | 125.6 | 116.7 | 9.1 | 7.8 |
| 6 | 114.7 | 114.2 | 111.5 | 113.5 | 1.7 | 1.5 |
| | 124.7 | 118.9 | 118.8 | 120.8 | 3.4 | 2.8 |

TABLE 4
(S & S AE100)

| | Cross Direction | | | | | |
|---|---|---|---|---|---|---|
| | Track 1 | Track 2 | Track 3 | Avg. | Std dev | % CV |
| 1 | 90.2 | 79.8 | 76.1 | 82.0 | 7.3 | 8.9 |
| | 86.0 | 82.0 | 72.1 | 80.0 | 7.1 | 8.9 |
| 2 | 83.6 | 81.7 | 72.6 | 79.3 | 5.9 | 7.4 |
| | 88.8 | 86.3 | 73.5 | 82.8 | 8.2 | 9.9 |
| 3 | 97.5 | 80.1 | 72.9 | 83.5 | 12.6 | 15.1 |
| | 91.7 | 78.7 | 74.8 | 81.7 | 8.9 | 10.9 |
| 4 | 75.1 | 79.6 | 85.4 | 80.0 | 5.1 | 6.4 |
| | 73.8 | 80.6 | 83.3 | 79.2 | 4.9 | 6.2 |
| 5 | 78.6 | 78.7 | 83.5 | 80.2 | 2.8 | 3.5 |
| | 73.0 | 81.2 | 77.8 | 77.3 | 4.1 | 5.4 |
| 6 | 74.6 | 75.3 | 81.5 | 77.2 | 3.8 | 4.9 |
| | 75.4 | 77.1 | 77.6 | 76.7 | 1.1 | 1.5 |

TABLE 5
(Cuno)
Roll Map -
99M00107

| | Cross Direction | | | | | |
|---|---|---|---|---|---|---|
| | Track 1 | Track 2 | Track 3 | Avg-3 | Std dev | % CV |
| 1 | 80.0 | 75.8 | 81.0 | 78.9 | 2.8 | 3.5 |
| | 78.6 | 78.5 | 82.2 | 79.8 | 2.1 | 2.6 |
| 2 | 77.4 | 75.9 | 81.9 | 78.4 | 3.1 | 4.0 |
| | 78.6 | 77.3 | 78.2 | 78.0 | 0.6 | 0.8 |
| 3 | 78.8 | 75.1 | 80.4 | 78.1 | 2.7 | 3.5 |
| | 78.8 | 78.5 | 82.7 | 80.0 | 2.4 | 3.0 |
| 4 | 78.0 | 76.9 | 80.0 | 78.3 | 1.6 | 2.0 |
| | 77.7 | 79.5 | 81.4 | 79.5 | 1.9 | 2.4 |
| 5 | 77.6 | 77.4 | 80.6 | 78.6 | 1.8 | 2.3 |
| | 79.9 | 79.5 | 81.7 | 80.4 | 1.2 | 1.5 |
| 6 | 81.5 | 78.7 | 82.6 | 80.9 | 2.0 | 2.5 |
| | 80.9 | 85.3 | 81.0 | 82.4 | 2.5 | 3.0 |
| 7 | 81.4 | 77.3 | 81.1 | 79.9 | 2.3 | 2.9 |
| | 81.8 | 80.2 | 83.3 | 81.8 | 1.5 | 1.9 |
| 8 | 76.9 | 76.0 | 77.4 | 76.8 | 0.7 | 1.0 |
| | 78.5 | 77.8 | 82.8 | 79.7 | 2.7 | 3.4 |
| 9 | 76.9 | 80.4 | 79.9 | 79.0 | 1.9 | 2.4 |
| | 79.5 | 79.7 | 79.1 | 79.5 | 0.3 | 0.4 |

The data of Table 5 arranged as a function of position down web, is shown below in Table 6:

[chemical structure]

As can be seen, the coefficient of variation percent (CV %) indicated by the above data represents a competitive advantage, when compared to CV % of standard membranes produced by other manufactures, as shown below in Table 7.

The sampling plan for the roll map of Example 1 was designed to provide the same orientation and location information with regard to track position as had been provided using the shorter (10 ft. length) sample rolls of competitor membrane. The length of the roll of the Cuno membrane was about nine hundred fifty (950) feet. The produced is then dissected into nine (9) separate sub-sample rolls of about one hundred (100) feet long, and each of the nine (9) sub-sample rolls was sampled and tested for its water wicking rate as described above, where wicking is measured on samples cut about one inch (1″) wide by about three inches (3″) high, oriented such that the capillary rise occurred in the crossweb direction (as opposed to the machine direction). For simplicity in visual organization, only the first six (6) sub samples of Cuno are carried into Table 7.

TABLE 7
(Summary of Competitive Analysis)

| | Competitive membranes | | Example 1 Roll map |
|---|---|---|---|
| % CV | Pall A5 | S & S AE100 | Cuno 99M001-07 |
| 1a | 7.0 | 8.9 | 3.5 |
| 1b | 10.7 | 8.9 | 2.6 |
| 2a | 8.0 | 7.4 | 4.0 |
| 2b | 8.5 | 9.9 | 0.8 |
| 3a | 9.1 | 15.1 | 3.5 |
| 3b | 8.8 | 10.9 | 3.0 |
| 4a | 0.9 | 6.4 | 2.0 |
| 4b | 9.7 | 6.2 | 2.4 |
| 5a | 12.5 | 3.5 | 2.3 |
| 5b | 7.8 | 5.4 | 1.5 |
| 6a | 1.5 | 4.9 | 2.5 |
| 6b | 2.8 | 1.5 | 3.0 |

A graphic representation of the data moving from position to position down the length is shown below in Table 8:

[chemical structure]

Again, the data clearly demonstrated the improvement in uniformity of wicking rate for the present disclosure over the membranes that are currently commercially available.

Thus, the data summarized above indicates that a superior lateral flow wicking rate membrane having high uniformity and easy processability into finished lateral flow in vitro diagnostic test kits can be produced by the present inventive combination of a reinforced, highly uniform large pore size microporous membrane and a highly uniform scrim substrate as disclosed herein.

### Example 2

In this example, a test was conducted to compare the wicking fronts of the Cuno, Inc. and the competition membrane. To assist in visualization of the wicking front, Orange G stain was used as a substitute for D.I. water. The membranes used for the wicking front test were L090C0A and Biodyne B (Pall).

In preparation for the test, sample membrane is removed from rolls and sandwiched in release paper. Specifically, approximately one inch (1″) by approximately three inch (3″) Cross Directional samples were cut in a manner known in the art.

A stock solution of D.I. water (adjusted to a pH of about 4.0+/− 0.1 with acetic acid) is produced, with the actual pH value being from about 4.03 to about 4.04.

About 0.100 grams of Orange G is measured using an analytical scale and mixed with about 100 ml of the pH 4 acetic acid stock solution.

About 1 ml of Orange G stain solution is then substituted for D.I. water in the wicking test. When the stain line met the fourth step on the wicking block, the sample is removed from the wicking block. The membrane end, which is in the well of the wicking block, is blotted with Kimwipes, and the sample is suspended from a binder clip to dry at room temperature.

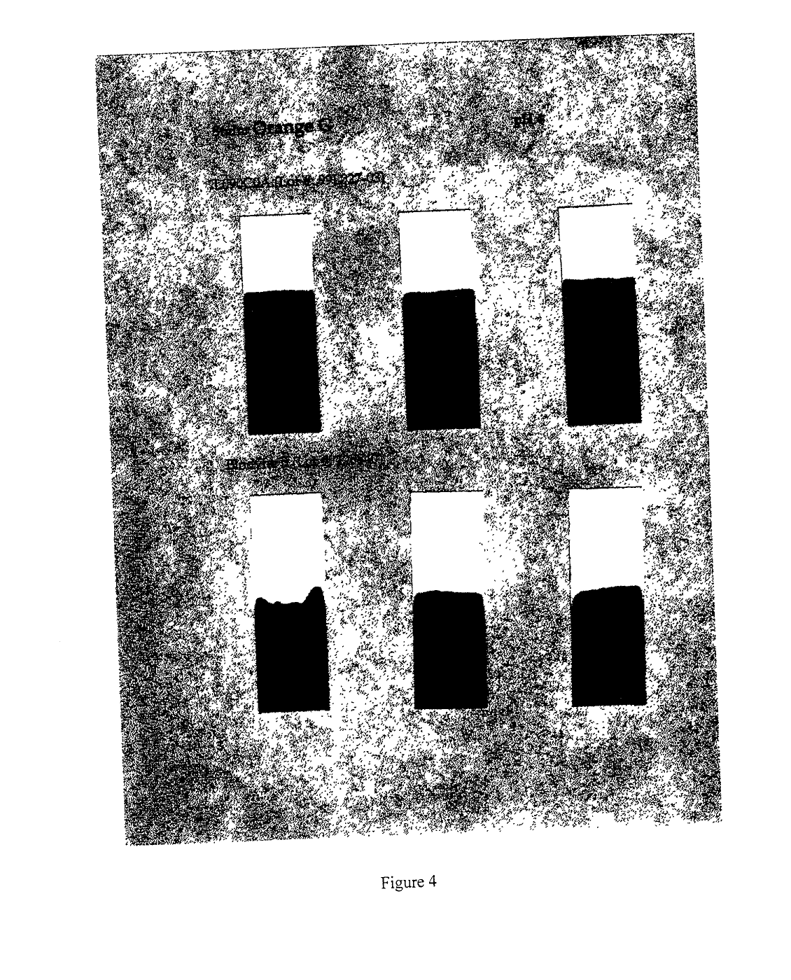

As can be seen from FIG. 4, the Cuno lateral flow reinforced microporous membrane exhibited straight line-like wicking fronts in all three samples. In contrast, Pall membrane exhibited a wavelike wicking front for two of the three samples. This data demonstrated that the inventive membrane of the present application clearly provided a more consistent wicking front than the Pall product.

### Prophetic Example 1

hCG Detection Test

A reinforced microporous membrane for lateral flow applications using the present disclosure is prepared in accordance with Example 1 above. Differences between the membrane of Example 1 and the lateral flow membrane used as prophetic example 1 are described below. The reinforced microporous membrane produced is used in a lateral flow sandwich assay for detection of human chorionic gonadotropin (hCG) commonly used in home pregnancy test kit. The reinforced microporous membrane that is prepared such that the capillary wicking of the individual strips occurs in the cross web direction.

Preparation of Nylon Membrane Test Strips

The membrane used in the hCG detection test in the prophetic Example 1 is most likely be 99M00106. The membrane is made by exactly the same method as actual Example 1.

The mother dope comprises about twelve percent (12%) by weight Nylon 66 (Dupont Zytel E53), about eighty-one and four-tenths percent (81.4%) by weight formic acid and about six and six-tenth percent (6.6%) by weight methanol.

The finished lab cast membrane has a thickness of about 8.1 mils, an Initial Bubble Point of about 20.4 psi and a Foam All Over Point of about 22.3 psi. This is evidence that the mother dope, as formulated and produced for this prophetic example, has a nominal pore size of about 0.8 microns prior to processing by a Dial-A-Por™ unit, and further processing into a large pore size microporous nylon membrane by a vertical casting apparatus at a dope processing site.

The specific target temperature for the Dial-A-Por™ unit is about fifty-three and one half degrees Celsius (53.5° C.) to effect a substantially lower bubble point dope attribute, followed by cooling to about twenty-one degrees Celsius (21° C.), to effect a useful dope viscosity for impregnation and coating.

At the dope processing site, a highly uniform non-woven polyester fiber web or scrim suitable for preparation of the lateral flow membrane (commercially available from Ahlstrom, Inc. Product Grade # Hollytex 3703), having a basis weight of nominally 1.06 oz./sq.yd. (36 gm./sq.meter) is processed by the method taught in the Ser. Nos. 09/040,979 and 09/040,816 applications. The scrim is pre-treated with a mild corona discharge to enhance its wettability before being pressure impregnated. The relatively larger pore size dope, is provided from the Dial-A-Por™ unit operatively connected to the first slot die (or Membrane Zone One impregnating die) and is used to pressure impregnate the scrim, with an impregnation weight of about ten and nine-tenths grams per square meter (10.9 gm./m²) of nylon solids. The nylon solids are provided from the dissolved nylon in the dope solution, which is, in this example, a twelve percent by weight (12 wt. %) nylon solution (about ninety-one, 91, grams of liquid dope per square meter), which is sufficient to impregnate and fill the void volume of the scrim, and leave a small excess of coating dope on the application side of the scrim creating the first zone of large pore size dope integral with the supporting scrim.

The relative amounts of dope per side are adjusted to roughly balance the total coating weight on both sides, and result in a finished coating weight of approximately thirty-four (34) grams of nylon solids per square meter (including impregnation weight); therefore, approximately twenty-three and one-tenth (23.1) grams per square meter are distributed between the other two coating slot dies.

The resultant three-zone, geometrically symmetric, pore size symmetric reinforced nylon microporous lateral flow membrane of this Example has the measured attributes as illustrated in the following Table 9.

TABLE 9

| | MFP | Thick | FAOP | IBP | Tₘₐₓ | Wicking Time-CD |
|---|---|---|---|---|---|---|
| Roll | um | Mils | psi | psi | ° C. | sec |
| 99M00106 | 4.306 | 6.3 | 4.7 | 3.5 | 53.5 | 80 |

A monoclonal anti-beta hCG antibody is conjugated to 40 nm gold particles then back-coated with Bovine Serum Albumin plus stabilizing reagents. (The conjugate.)

A monoclonal anti alpha hCG antibody is applied to a strip of nylon membrane (30 cm×2.5 cm) using a BioDot™ dispenser to provide a discrete line along the center of the membrane length. (The capture zone.)

The striped nylon membrane is blocked using a casein sucrose solution and then dried at 45° C.

A sample pad is attached along the top length of the membrane.

An absorbent pad is attached along the bottom length of the membrane.

The membrane is cut to produce 5 mm×2.5 cm test strips. The sample pad is located at the beginning of the test strip.

The strip is inserted into a housing such that a sample delivery port is located above the sample pad and a visualization window above the capture zone read-out area.

A series of hCG standards are prepared in PBS containing 2% Bovine Serum Albumin at 1000, 100, 25, 12.5, 6.25 mIU/ml and zero mIU/ml.

Performance of Test

10 μl of conjugate is added to the sample pad.

100 μl standard is added to the sample delivery port in the housing and reagents are allowed to migrate to the terminal end of the membrane.

After the conjugate has passed beyond the visualization window, the results are read. The data are summarized in the table below.

hCG mIU/ml Visual Signal Intensity at Capture Zone

| mIU/ml | Visual | rating |
|---|---|---|
| 1000 | Strong | 4 |
| 100 | Visible | 2 |
| 25 | Slightly Visible | 1 |
| 12.5 | Undeterminable | — |
| 6.25 | Undeterminable | — |
| 0 | Negative | 0 |

Any visual color at the capture zone is indicative of the presence of hCG in the sample.

It is expected that the use of the present inventive lateral flow membrane in this prophetic example of a pregnancy test kit will, by the methods suggested here, provide at least an acceptable sensitivity level of 100 mIU hCG in clinical trials, thus demonstrating a commercially useable pregnancy test. It is also expected that, with further research and development concerning the chemistry of the test, that even more sensitive assays can be realized.

### Prophetic Example 2

A reinforced microporous membrane for use in lateral flow IVD applications based on the present disclosure is prepared in accordance with Example 1 above. Differences between the membrane of Example 1 and the lateral flow membrane used in prophetic example 2 below are described below. The reinforced microporous membrane produced is used to produce a lateral flow competitive assay for a morphine detection test kit. The reinforced microporous membrane strips used are oriented such that the capillary wicking of the individual strips is in the cross web direction.

Morphine Detection Test—A Competitive Inhibition Test.

The mother dope is identified as Dope # 99J086, and comprises about fourteen and five-tenths percent (14.5%) by weight Nylon 66 (Solutia Vydyne 66Z), about seventy-nine and two-tenths percent (79.2%) by weight formic acid and about six and three-tenths percent (6.3%) by weight methanol, is produced by the method disclosed in U.S. Pat. Nos. 3,876,738 and 4,645,602.

The finished lab cast membrane has a thickness of about 8.8 mils, Initial Bubble Point of about 19.6 psi and a Foam All Over Point of about 21.2 psi. This is evidence that the mother dope, as formulated and produced for this prophetic example, has a nominal pore size of about 0.8 microns prior to being processed by a Dial-A-Por™ unit, and further processed into large pore size microporous nylon membrane by a vertical casting apparatus at a dope processing site.

The specific target temperature for the Dial-A-Por™ unit is fifty-seven and six tenths degrees Celsius (57.6° C.) to effect a substantially lower bubble point dope attribute, followed by cooling to about twenty-one degrees Celsius (21° C.,) to effect a useful dope viscosity for impregnation and coating.

At the dope processing site, a highly uniform non-woven polyester fiber web or scrim suitable for preparation of the lateral flow membrane (commercially available from Ahlstrom, Inc. Product Grade # Hollytex 3703), having a basis weight of nominally 1.06 oz./sq.yd. (36 gm./sq.meter) is processed by the method taught in the Ser. Nos. 09/040,979 and 09/040,816 applications. The scrim is pre-treated with a mild corona discharge to enhance its wettability before being pressure impregnated. The relatively larger pore size dope, is provided from the Dial-A-Por™ unit operatively connected to the first slot die (or Membrane Zone One impregnating die) and is used to pressure impregnate the scrim, with an impregnation weight of about ten and nine-tenths grams per square meter (10.9 gm./sq.meter) of nylon solids. The nylon solids are provided from the dissolved nylon in the dope solution. In this example, a fourteen and one half percent by weight (14.5 wt. %) nylon solution (about seventy-five, 75, grams of liquid dope per square meter) is used, which is believed to be sufficient to impregnate and fill the void volume of the scrim, and leave a small excess of coating dope on the application side of the scrim creating the first zone of large pore size dope integral with the supporting scrim.

The relative amounts of dope per side are adjusted to roughly balance the total coating weight on both sides, and should result in a finished coating weight of approximately thirty-four (34) grams of nylon solids per square meter (including impregnation weight); therefore, approximately twenty-three and one-tenth (23.1) grams per square meter are distributed between the other two coating slot dies.

The expected resultant three-zone, geometrically symmetric, pore size symmetric reinforced nylon microporous lateral flow membrane of this Example has the measured attributes as illustrated in the following Table 10.

TABLE 10

| | MFP | Thick | FAOP | IBP | Tₘₐₓ | Wicking Time-CD |
|---|---|---|---|---|---|---|
| Roll | um | Mils | psi | psi | ° C. | sec |
| 99J08605 | 6.232 | 5.6 | 5.1 | 4.2 | 57.6 | 74.6 |

Preparation of Nylon Membrane Test Strips

A monoclonal anti-morphine antibody is conjugated to gold colloid particles and the conjugate is back-coated with Bovine Serum Albumin plus stabilizing reagents. (The conjugate.)

A soluble morphine/BSA complex is applied to a strip of nylon membrane (30 cm×2.5 cm) using a BioDot™ dispenser to produce a discrete line along the center of the membrane length—perpendicular to the cross-web direction. (The capture zone.)

The striped nylon membrane is blocked using a casein sucrose solution and then dried for 40 minutes at 45° C.

The test strips are assembled as in prophetic Example 1.

A series of morphine standards are prepared in potassium phosphate buffer containing 0.25% BSA at 1000, 100, 20, 10, ng/ml and zero ng/ml.

3 μl conjugate is added to the sample pad.

110 μl standard is added to the sample delivery port of the housing and reagents are allowed to migrate to the terminal end of the membrane.

After conjugate has passed beyond the visualization window, the results are read, and the data appears below.

Morphine ng/ml Visual Signal Intensity

| mIU/ml | Visual | rating |
|---|---|---|
| 1000 | Negative | 0 |
| 100 | Negative | 0 |
| 20 | Undeterminable | ? |
| 10 | Undeterminable | ? |
| 0 | Visible | 3-5 |

No visual signal is indicative of the presence of morphine in the sample at a level greater than 10 ng/ml. A visual signal is indicative of the absence of morphine or the presence of morphine at the minimum level of test sensitivity. In general, for these tests, this signal will typically visualize when there is less than about 20 ng/ml in the sample but remain blank past a particular upper threshold; the ability to reliably remain blank against all background noise, at the lowest possible concentration of morphine is the goal of a sensitive test.

It is expected that the use of the present inventive lateral flow membrane in a morphine drug of abuse test kit will, by the methods suggested here, provide at least an acceptable sensitivity level of between 20 and 100 ng/ml of morphine in clinical trials, thus demonstrating a commercially useable drug-of-abuse test. It is also expected that, with further research and development concerning the chemistry of the test, that even more sensitive assays can be realized.

Based on the foregoing, it should be clear that the membrane of the present application solves the need for membranes that can be used more effectively in immunodiagnostic assays for lateral flow IVD applications. The membrane of the present application clearly possess better tensile strength to facilitate handling and converting than the current prior art membrane used in lateral flow diagnostic applications. The membrane of the present application clearly has fast, consistent and uniform wicking properties for dependable performance and accurate results when used in lateral flow diagnostic applications. The membrane of the present application clearly at least reduces, if not eliminates, weak membrane strength when used in lateral flow diagnostic applications. The membrane of the present application clearly at least reduces, if not eliminates, inconsistent wicking associated with nitrocellulose membrane when used in lateral flow diagnostic applications.

While the articles and methods of using and making the articles described herein constitute preferred embodiments of the disclosure, it is to be understood that the disclosure is not limited to these precise articles and methods and that changes may be made therein without departing from the scope of the disclosure which is defined in the appended claims.

What is claimed is:

1. A microporous membrane comprising:
at least one porous scrim substantially encapsulated by a microporous polymer such that the microporous membrane provides a uniform wicking rate when used in lateral flow applications, wherein the porous scrim has a basis weight of about ten (10) to about sixty (60) g/m².

2. The membrane of claim 1, wherein the microporous membrane further comprises:
a uniform wicking front when used in lateral flow applications.

3. The membrane of claim 1, wherein the porous scrim has a thickness of about one (1.0) to about four (4.0) mils.

4. The membrane of claim 1, wherein the porous scrim has a basis weight of about twenty-five (25) to about forty-five (45) g/m².

5. The membrane of claim 1, wherein the porous scrim has a basis weight of about thirty (30) to about forty-two (42) g/m².

6. The membrane of claim 1, wherein the porous scrim has a basis weight of about thirty seven (37) g/m².

7. The membrane of claim 1, wherein the scrim must have a minimum tensile strength of about three (3) lb./in. minimum for the cross direction (CD).

8. The membrane of claim 1, wherein the scrim must have a minimum tensile strength of about five (5) lb./in. minimum for the machine direction (MD).

9. The membrane of claim 1, wherein the scrim must have a Frazier air permeability of about ten (10) CFM minimum to about five hundred (500) CFM.

10. The membrane of claim 1, wherein the scrim must have a Frazier air permeability of about fifteen (15) to about one hundred fifty (150) CFM.

11. The membrane of claim 1, wherein the scrim must have a Frazier air permeability of about twenty (20) to about thirty-five (35) CFM.

12. The membrane of claim 1, wherein the scrim must have a Frazier air permeability of about twenty four (24) CFM.

13. The membrane of claim 1, wherein the scrim has a MFP (Mean Flow Pore) pore size of about 17.7 um.

14. The membrane of claim 1, wherein the microporous polymer has a nominal pore size of about 1 um to about 20 um.

15. The membrane of claim 1, wherein the microporous polymer has a pore size of about 5 um to about 15 um.

16. The membrane of claim 1, wherein the microporous polymer has a pore size of about 8 um to about 12 um.

17. The membrane of claim 1, wherein the microporous polymer has a pore size of about 11 um.

18. The membrane of claim 1, wherein the polymer used to make the scrim is a wetlaid polyester short-fiber mat, containing an acrylic binder, calendered to a density which would render it less than desirable for filtration membrane purposes.

19. The membrane of claim 1, wherein the polymer fiber used to make the scrim comprises:
a base polymer fiber and a binder polymer fiber or binder formulation.

20. The membrane of claim 1 wherein the polymer fiber used to make the scrim is a bicomponent fiber having an outer sheath polymer suitable for use as a binder, and an inner core polymer suitable for use as a structural reinforcement.

21. The membrane of claim 1, wherein the scrim is made of polyester.

22. The membrane of claim 1 wherein the scrim is made of polypropylene.

23. The membrane of claim 22, wherein the porous scrim has a basis weight of about twenty (20) to about thirty-five (35) g./ m².

24. The microporous membrane of claim 1 wherein, the reinforced membrane is physically strong, as compared to nitrocellulose membrane, useful in lateral flow immunodiagnostic assay applications.

25. The microporous membrane of claim 1 wherein, the reinforced membrane has increased tensile strength, as compared to nitrocellulose membrane, when used in lateral flow immunodiagnostic assay applications.

26. The microporous membrane of claim 1 wherein, the reinforced membrane has a low coefficient of variation (CV) in its flow characteristics when used in lateral flow immunodiagnostic assay applications.

27. The microporous membrane of claim 1 wherein, the reinforced membrane has a sufficiently high binding capacity to retain capture zone molecules in lateral flow immunodiagnostic assay applications.

28. The microporous membrane of claim 1 wherein, the reinforced membrane has a fast and reproducible wicking rate.

29. The microporous membrane of claim 1 wherein, the reinforced membrane's non-specific binding can be controllably blocked in lateral flow immunodiagnostic assay applications.

30. The microporous membrane of claim 1 wherein, the reinforced membrane has improved uniformity when used in lateral flow immunodiagnostic assay applications.

31. The microporous membrane of claim 1 wherein, the reinforced membrane that is water wettable without surfactants when used in lateral flow immunodiagnostic assay applications.

32. The microporous membrane of claim 1 wherein, the reinforced membrane includes a reinforcing scrim which exhibits high uniformity of properties on the scrim surface, exhibits high uniformity of thickness, exhibits high uniformity of distribution of fibers, and exhibits high uniformity of macro and micro appearance when used in reinforced microporous membrane for lateral flow diagnostic assay applications.

33. A method of preparing a reinforced microporous membrane comprising the acts of:
selecting a scrim having the properties from the group comprising:
a fiber forming polymer, including but not limited to polyesters, polyamides, polyimides and polyolefins or combination of polymers in fibrous form capable of forming a fibrous web or mat which is useful as a membrane casting substrate either directly after formation or after post treatments such as binder addition, calendering and corona treatment, the polymer fibers or blend of fibers or blend of fibers and binder(s) may be also treated during formation with the addition of a non-fibrous binder formulation.;
a basis weight of about ten (10) to about sixty (60) g./m²,
a thickness of about one (1.0) to about four (4.0) mils;
a tensile strength of about three (3) lb./in. minimum for the cross direction (CD) and about five (5) lb./in. minimum for the machine direction (MD) and
a Frazier air permeability of about ten (10) CFM minimum to about five hundred (500) CFM;
providing the selected scrim as a continuous support material having first and second sides;
at least substantially pressure impregnating the scrim with a first polymer dope; and
effectuating the transformation of the first dope into a microporous polymer.

34. The method of claim 33, further comprising the acts of:
after the act of at least substantially pressure impregnating the scrim with a first polymer dope utilizing a first die means,
passing the polymer dope impregnated continuous scrim between substantially opposed second and third die means; and
prior to the effectuating act, substantially simultaneously coating both sides of the first polymer dope impregnated continuous support material with the same polymer dope to produce a membrane having a relatively large pore size, of high uniformity.

35. The method of claim 33, wherein the basis weight comprises:
about twenty-five (25) to about forty-five (45) g/m².

36. The method of claim 33, wherein the basis weight comprises:
about thirty (30) to about forty-two (42) g/m²;.

37. The method of claim 33, wherein the basis weight comprises:
has a basis weight of about thirty seven (37) g/m².

38. The method of claim 33, wherein, the scrim Frazier air permeability comprises:
about fifteen (15) to about one hundred fifty (150) CFM.

39. The method of claim 33, wherein the scrim Frazier air permeability comprises:
about twenty (20) to about thirty-five (35) CFM.

40. The method of claim 33, wherein the scrim is a wetlaid polyester short-fiber mat, containing an acrylic binder, calendered to a density which would render it less than desirable for filtration membrane purposes.

41. The method of claim 33, wherein the scrim is a Polyethylene Terephthalate (PET), or a combination of Polyethylene Terephthalate/Polyethylene Imine (PET/PEI) fiber blend, where the PEI fiber is used as a binder fiber.

42. The method of claim 33, wherein the scrim is treated with a separate polymeric treatment, such as an acrylic binder, to effect bond strength and uniform tie-down of the structural PET fiber mat.

43. A method of using the membrane of claim 1 to detect an analyte of interest comprising:
contacting the membrane with a fluid believed to contain the analyte of interest; and
detecting the analyte of interest if present in the fluid.

44. A method of using the membrane of claim 1 to detect an analyte of interest comprising:
contacting the membrane with a fluid comprising the analyte of interest; and
detecting the analyte of interest on the membrane.

45. An immunodiagnostic assay kit comprising the membrane of claim 1 and a means for detecting an analyte of interest, a physically strong, reinforced membrane, as compared to nitrocellulose membrane, useful in lateral flow immunodiagnostic assay applications

46. A microporous membrane comprising:
at least one porous scrim substantially encapsulated by a microporous polymer such that the microporous membrane provides a uniform wicking rate when used in lateral flow applications, wherein the porous scrim has a thickness of about 3 mils, a basis weight of about 37 g/m², a cross direction of about 5.3 lb./in. tensile strength, a machine direction of about 8.6 lb./in. tensile strength and a Frazier air permeability of about 24 CFM.

47. A three zone microporous membrane suitable for use in immunodiagnostic assays comprising:
a porous scrim substantially encapsulated by a microporous polymer to form a middle zone having two sides; and
a second zone and a third zone formed from the same microporous polymer as the middle zone, each zone having inner and outer surfaces, each of the second and third zones being operatively, continuously, connected to opposite sides of the middle zone, such that the microporous membrane provides a uniform wicking rate when used in lateral flow applications, wherein the porous scrim has a thickness of about 3 mils, a basis weight of about 37 g/m², a cross direction of about 5.3 lb./in. tensile strength, a machine direction of about 8.6 lb./in. tensile strength and an air permeability of about 24 CFM.

48. A microporous membrane comprising:
at least one porous scrim substantially encapsulated by a nylon polymer such that the microporous membrane provides a uniform wicking rate when used in lateral flow applications, wherein the porous scrim has a basis weight of about ten (10) to about sixty (60) g/m².
